(19) United States
(12) Patent Application Publication
(10) Pub. No.: US 2002/0186200 A1
(43) Pub. Date: Dec. 12, 2002

(54) Method and apparatus for human interface with a computer

(76) Inventor: David Green, Thornhill (CA)

Correspondence Address: COLLIER, SHANNON, SCOTT, PLLC, 3050 K STREET, NW, SUITE 400, WASHINGTON, DC, 20007, US

(21) Appl. No.: 09/876,031

(22) Filed: Jun. 8, 2001

(51) Int. Cl. G09G 5/00

(52) U.S. Cl. 345/156

(57) ABSTRACT

The method and apparatus for human interface with a computer is a system for providing control signals to a computer comprising a tube-like member adapted to reside on a finger of a computer user having a distinct knuckle surface color and a distinct palm surface color, a camera operatively connected to the computer and adapted to view the member, and a means for converting a member surface color viewed by the camera into a control signal for the computer

### FIELD OF THE INVENTION

The present invention relates to a method and apparatus for the user of a computer to provide input to the computer. The method and apparatus replace or supplement inputs traditionally provided by a computer mouse.

### BACKGROUND OF THE INVENTION

At the present time, human interface with most personal computers (PCs) is provided through the use of a keyboard and a mouse. A typical mouse is hardwired to the PC and requires that the computer user physically manipulate the mouse in order to input control signals to the PC. Movement of the mouse over the flat planar surface of a mouse pad may be used to move a cursor icon about the PC screen. Once the cursor icon is in a desired location on the PC screen, the user may “click” one or more of a plurality of buttons provided on the mouse to select an item at the screen location. Although a mouse is fairly simple to use, it requires a fairly sizeable clean flat surface for proper functioning. In some cases, mouse operation is hindered by the lack of a clean flat surface for a mouse pad in the vicinity of the computer. Further complication may arise if the range of mouse motion over the mouse pad required for operation of the computer exceeds the range of motion of the user. Such a situation may occur, when, for example, the user is disabled or is a child. Accordingly, there is a need for an apparatus that can provide the functionality of a mouse (i.e. cursor movement and “clicking”) without the need for a clean flat surface near the computer or the need for extensive motion by the user.

Keyboards are also typically hardwired to the PC and are designed to receive press down input from the computer user's fingers. Although keyboards may be used to rapidly input textual information, they require well developed user dexterity and understanding. Thus, the proper use of keyboards may be quite challenging for disabled persons or children. Accordingly, there is a need for an apparatus that can provide the functionality of a keyboard (i.e. input of textual information) without the need for highly developed user dexterity.

In the most basic sense, both a mouse and a keyboard provide the same functionality, they receive and transmit a user selection. User selection may be indicated by any change initiated by the user, such as pressing a keyboard key or clicking a mouse button. Accordingly, a candidate for replacement of either of these devices must also be able to receive and transmit a user selection by detecting a change initiated by the user.

Over the past decade, advances in computer based color recognition and hand gesture recognition have been used to provide substitutes for a computer mouse and keyboard. Color recognition may be used to signal a user selection by detecting the user's change of a color displayed to a camera connected to the computer. Hand gesture recognition may be used to signal a user selection by detecting a change in the user's hand position as viewed by a camera connected to the computer. Examples of color recognition and hand gesture recognition systems, including some that use such recognition for control of a cursor on a screen, are provided in the following patents, each of which is incorporated by reference herein: (Color recognition: U.S. Pat. Nos. 4,488,245; 4,590,469; 4,678,338; 4,797,738; 4,917,500; 4,954,972; 5,012,431; 5,027,195; 5,117,101; and 5,136,519) (Gesture recognition: U.S. Pat. Nos. 4,988,981; 5,291,563; 5,423,554; 5,454,043; 5,594,469; 5,798,758; and 6,128,003). The gesture recognition systems that use only one camera are of most relevance to the various embodiments of the present invention, which also employ a single camera.

Although both color recognition and gesture recognition have been used generically to record user control signals, the systems employing these techniques have typically been complicated and/or finicky, requiring the use of a relatively high resolution camera for optimum results. The complexity of the systems has been necessitated by the need to make certain that true color and gesture changes are being recorded. A system that incorrectly detected color or gesture changes would not be suitable for control of a computer, as the user would be frustrated quickly by the registration of erroneous control signals. Accordingly, there is a need for a system that uses color recognition and/or gesture recognition and that accurately records user input, but is less complicated than known systems and can operate with a lower resolution camera, such as a commonly available web cam.

Applicant has determined that the foregoing needs may be met by a system that utilizes a combination of color recognition, gesture (i.e. hand shape) recognition, and/or hand motion recognition to reduce the likelihood of the registration of erroneous user input signals, while at the same time permitting the use of a lower resolution camera, such as a web cam. The use of color recognition, gesture recognition, and/or motion recognition in combination provides redundancy that may be used for improved user input detection, decreased camera resolution, or some combination of both.

### OBJECTS OF THE INVENTION

It is therefore an object of the present invention to provide a system and method for providing control signals to a computer using color recognition and gesture recognition techniques.

It is another object of the present invention to provide a system and method for providing control signals to a computer using color recognition, gesture recognition, and motion recognition techniques.

It is another object of the present invention to provide a system and method for providing control signals to a computer using a relatively low resolution camera.

It is still another object of the present invention to provide a system and method for providing control signals to a computer with improved user input detection.

It is yet another object of the present invention to provide a system and method for providing control signals to a computer that may be used by disabled persons and/or children.

Additional objects and advantages of the invention are set forth, in part, in the description which follows and, in part, will be apparent to one of ordinary skill in the art from the description and/or from the practice of the invention.

### SUMMARY OF THE INVENTION

In response to the foregoing challenges, Applicant has developed an innovative system for providing control signals to a computer, the system comprising a tube-like member adapted to reside on a finger of a computer user, the member having a distinct knuckle surface color and a distinct palm surface color, a camera operatively connected to the computer and adapted to view the member, and a means for converting a member surface color viewed by the camera into a control signal for the computer.

Applicant has also developed an innovative system for providing control signals to a computer, the system comprising a member adapted to reside on a finger of a hand of a computer user, the member having a distinct knuckle surface color and a distinct palm surface color, a camera operatively connected to the computer and adapted to view the member, and means for converting a user hand position and a member surface color viewed by the camera into a control signal for the computer.

Applicant has also developed an innovative apparatus for providing control signals to a computer, the apparatus being adapted to reside on the finger of a computer user and comprising a knuckle surface having a first color, and a palm surface having a second color.

Applicant has also developed an innovative method of providing control signals to a computer using a camera and a tube-like member having three distinctly colored surfaces, the method comprising the steps of placing the tube-like member on one of a plurality of fingers on a hand of a computer user, placing the tube-like member and the hand in the camera field of view, selectively varying positions of the tube-like member and at least one finger without the tube-like member, detecting a change in the color of the tube-like member colored surface in the camera field of view, detecting a change in the shape of the hand in the camera field of view, and generating a computer control signal responsive to the detection of a change in (a) the color of the tube-like member colored surface and (b) the shape of the hand.

It is to be understood that both the foregoing general description and the following detailed description are exemplary and explanatory only, and are not restrictive of the invention as claimed. The accompanying drawings, which are incorporated herein by reference, and constitute a part of the specification, illustrate certain embodiments of the invention, and together with the detailed description, serve to explain the principles of the present invention.

### BRIEF DESCRIPTION OF THE DRAWINGS

The invention will now be described in conjunction with the following drawings in which like reference numerals designate like elements and wherein:

FIG. 1 is a pictorial view of a computer control signal input system arranged in accordance with a first embodiment of the present invention;

FIG. 2 is a pictorial view of a tube-like member that may be used with the system shown in FIG. 1;

FIGS. 3-6 are pictorial views of various hand, finger, and tube-like member positions that may be assumed during practice of an embodiment of the invention;

FIG. 7 is a flow chart illustrating the steps of a method embodiment of the invention;

FIG. 8 is a pictorial view of a tube-like member formed by a cut-out finger puppet that may be used with the system shown in FIG. 1.

### DETAILED DESCRIPTION OF THE PREFERRED EMBODIMENTS

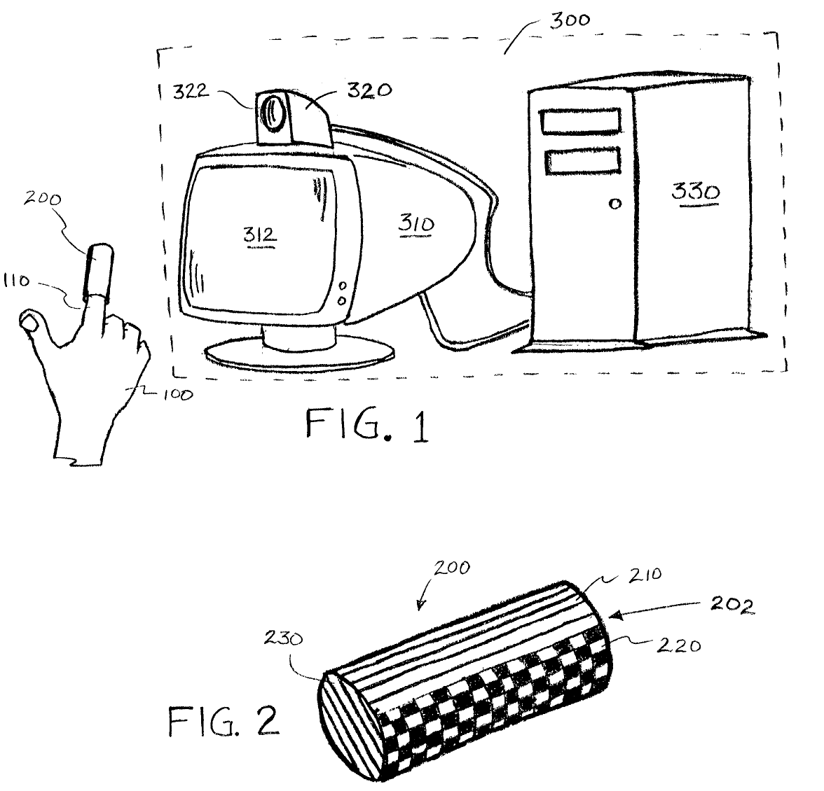

With reference to FIG. 1, a computer control signal input system arranged in accordance with a first embodiment of the invention is shown. The input system includes a hollow tube-like member 200 mounted on the index finger 110 of the hand 100 of a user. The user hand 100 is located in front of a computer 300. The computer 300 includes a monitor 310 having a viewable screen 312, a camera 320 having a lens 322, and a hardware device 330 having a processor, memory and other commonly known components of a PC. The monitor 310 and the camera 320 are operatively connected to the hardware device 330 by cables.

With reference to FIG. 2, the tube-like member 200 may include a knuckle side surface 210, and palm side surface 220, and a tip surface 230. In the preferred embodiment of the present invention, each of the knuckle, palm and tip surfaces are provided with a different and distinct color. The tube-like member 200 may be hollow and have an opening 202 at one end adapted to receive a finger of the user. Preferably, the tube-like member 200 is fitted to stay securely on the user's finger without rotating, while at the same time being comfortable to the user. When inserted on the user's finger properly, the knuckle side surface 210 of the member 200 should be substantially aligned with the knuckle side of the user's hand and the palm side surface 220 of the member should be substantially aligned with the palm side of the user's hand.

In alternative embodiments of the invention, the tube-like member 200 may be provided with only two distinct colors located on the knuckle side and the palm side of the member, respectively. The tip color of a tube-like member 200 with only two distinct colors may be provided by the color of the user's fingertip. In still other alternative embodiments, an example of which is shown in FIG. 8, the tube-like member 200 may be provided in the form of a finger puppet, having human or animal like features. The finger puppet may be cut out from paper or cardboard stock and glued, stapled, taped, or otherwise fashioned together to form a tube-like structure.

The camera 320 may be any commonly available camera for use with a PC, such as a web cam. The camera 320 is shown in a position atop of the monitor 310, however, it is appreciated that the camera could be located in other places in the general vicinity of the monitor. The horizontal polarity on the lens 322 of the camera may be reversed so that it also acts as a mirror for the user. The mirrored surface of the lens 322 may allow the user to see her hand positions as they are viewed by the camera 320.

The hardware device 330 may include one or more programs stored in memory that convert color changes and hand gesture changes viewed by the camera 320 into control signals.

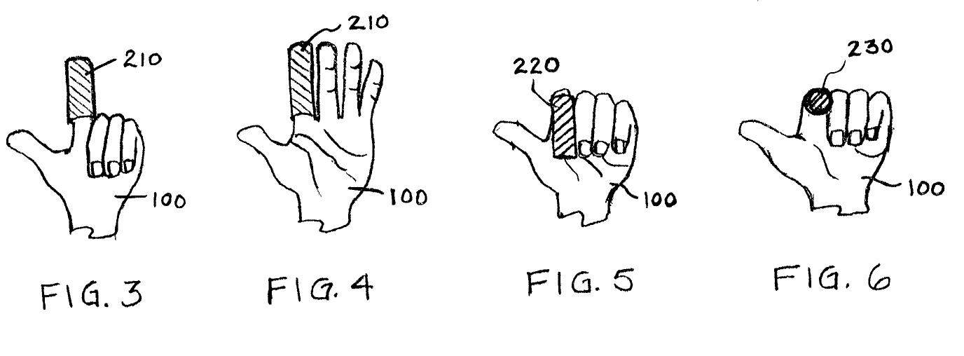

The input system may be operated as follows to provide control signals to the computer 300. With reference to FIG. 1, in a first step, the tube-like member 200 may be placed on one of a plurality of fingers 110 on the hand 100 of the computer user. The tube-like member 200 is aligned such that the knuckle side 210 of the member is on the knuckle side of the user's hand, and the palm side 220 of the member is on the palm side of the user's hand. Next, the user's hand 100, including the tube-like member 200 is placed in the field of view of the camera 320. The hand 100 may be in any of the positions shown in FIGS. 3-6 to initiate the process. It is assumed in this embodiment that the initiation position will be that shown in FIG. 4. The color recognition aspect of the computer program stored in the hardware device 330 may be used to locate the tube-like member 200, which should have a distinctive color. The location of the tube-like member 200 in the camera 320 field of view enables the system to locate and focus in on the general location of the hand 100 as well, because the hand is naturally near the tube-like member. In this manner, the color recognition aspect of this embodiment of the invention supplements the gesture recognition aspect by enabling the system to locate the hand for gesture recognition.

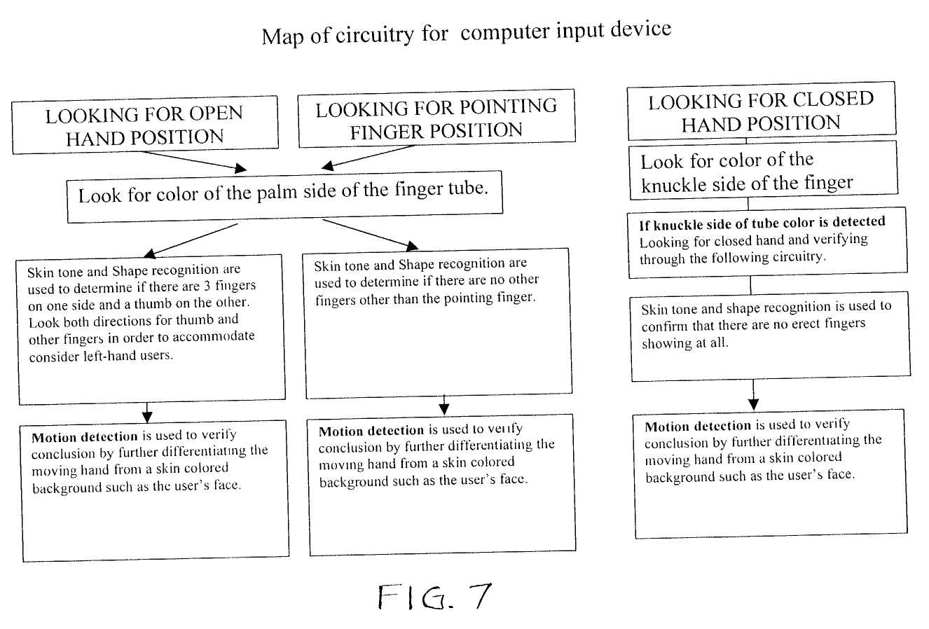

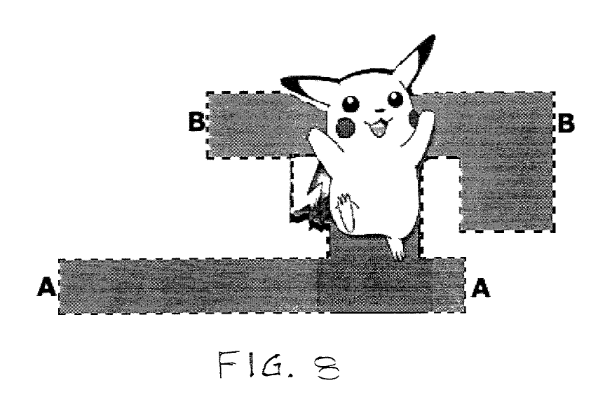

Pursuant to the steps illustrated in FIG. 7, the hardware device 330 uses the camera 320 to recognize the shape of the hand. Shape recognition (which may utilize recognition of the hand color as well) is used to distinguish between the open hand position (shown if FIG. 4), the pointing position (FIG. 3), and the closed hand position (FIG. 5). Movement of the hand 100 may also be detected to assist in distinguishing the hand from a flesh colored background, such a the user's face.

Thereafter, the position of the hand 100 and the tube-like member 200 may be selectively varied to any of the positions shown in FIGS. 3-6, as well as others. The camera sends the visual information regarding the hand 100 and the tube-like member 200 to the hardware device 330. Differences in the color of the displayed surface of the tube-like member 200 and the shape of the hand 100 are detected by the hardware device 330 and used for the generation of a computer control signal. The hardware device 330 detection of a change in the shape of the hand (gesture change) may be used to supplement the color change information for the computer control signal generation. In the preferred embodiment of the invention, the generation of the computer control signals is responsive to the detection of a combination of change in (a) the color of the tube-like member colored surface and (b) the shape of the hand.

Various hand 100 and tube-like member 200 positions may be used to signal various computer commands, such as cursor movement, clicking, double clicking, scrolling, etc. For example, in a preferred embodiment of the present invention, the hand 100 and tube-like member 200 position shown in FIG. 6 (with the tube pointed at the camera so that the tube tip color is viewed) may be used to control cursor movement over the monitor screen 312. By communicating with the computer's operating system the cursor is controlled by hand positions and motion. The hand 100 and tube-like member 200 position shown in FIG. 5 may be used to signal a “click.” When the hand and tube are in the position shown in FIG. 6, slight changes in the pointing direction of the index finger may be used to move the cursor about the monitor screen, to write on-screen, or to “finger” paint on-screen. The use of software such as Graffiti™ used in Palm OS™ may allow the user to convert hand writing into typed text.

Unlike other gesture recognition applications, in a preferred embodiment of the present invention, control signals are computed in response to the pointing finger's exposed colors, the luminance level of the tip and whether or not it is accompanied by neighboring fingers when in a pointing position. The system will not rely on differential keying, glob recognition, electronic sensors, or more than one camera. In addition, when pointed the top of the finger tube provides a precise reference point to use for drawing, painting and writing applications with accuracy well beyond that of a computer mouse or gesture recognition systems used for virtual reality games.

It is to be understood that the description and drawings represent the presently preferred embodiment of the invention and are, as such, a representative of the subject matter which is broadly contemplated by the present invention. It is further understood that the scope of the present invention fully encompasses other embodiments that may become obvious to those skilled in the art, and that the scope of the present invention is accordingly limited by nothing other than the appended claims.

What is claimed is:

1. A system for providing control signals to a computer, said system comprising:
a tube-like member adapted to reside on a finger of a computer user, said member having a distinct knuckle surface color and a distinct palm surface color;
a camera operatively connected to the computer and adapted to view said member; and
means for converting a member surface color viewed by the camera into a control signal for the computer.

2. The system of claim 1 wherein the tube-like member further comprises a distinct tip surface color.

3. The system of claim 1 wherein the tube-like member comprises a finger puppet.

4. The system of claim 1 wherein the tube-like member is comprised of paper.

5. The system of claim 1 wherein the camera comprises a web cam.

6. The system of claim 1 wherein the tube-like member further comprises a paper finger puppet having a distinct tip surface color, and
wherein the camera comprises a web cam.

7. The system of claim 1 wherein the camera further comprises a mirrored lens surface.

8. A system for providing control signals to a computer, said system comprising:
a member adapted to reside on a finger of a hand of a computer user, said member having a distinct knuckle surface color and a distinct palm surface color;
a camera operatively connected to the computer and adapted to view said member; and
means for converting a user hand position and a member surface color viewed by the camera into a control signal for the computer.

9. The system of claim 8 wherein the tube-like member further comprises a distinct tip surface color.

10. The system of claim 8 wherein the tube-like member comprises a finger puppet.

11. The system of claim 8 wherein the tube-like member is comprised of paper.

12. The system of claim 8 wherein the camera comprises a web cam.

13. The system of claim 8 wherein the tube-like member further comprises a paper finger puppet having a distinct tip surface color, and
wherein the camera comprises a web cam.

14. The system of claim 8 wherein the camera further comprises a mirrored lens surface.

15. An apparatus for providing control signals to a computer, said apparatus being adapted to reside on the finger of a computer user and comprising:
a knuckle surface having a first color; and
a palm surface having a second color.

16. The apparatus of claim 15 further comprising a tip surface having a third color.

17. A method of providing control signals to a computer using a camera and a tube-like member having three distinctly colored surfaces, said method comprising the steps of:
placing the tube-like member on one of a plurality of fingers on a hand of a computer user;
placing the tube-like member and the hand in the camera field of view;
selectively varying positions of the tube-like member and at least one finger without the tube-like member;
detecting a change in the color of the tube-like member colored surface in the camera field of view;
detecting a change in the shape of the hand in the camera field of view, and
generating a computer control signal responsive to the detection of a change in (a) the color of the tube-like member colored surface and (b) the shape of the hand.

18. The method of claim 17 wherein the step of detecting a change in the color of the tube-like member colored surface comprises detecting a colored surface selected from the group consisting of: a distinctly colored knuckle surface, a distinctly colored palm surface, and a distinctly colored tip surface.

19. The method of claim 17 further comprising the step of detecting motion of the hand to distinguish the hand from a background color.
